(19) United States
(12) Patent Application Publication
(10) Pub. No.: US 2012/0160178 A1
(43) Pub. Date: Jun. 28, 2012

(54) STACKABLE AQUARIUM ASSEMBLY

(75) Inventor: Teddy LUONG, Markham (CA)

(73) Assignee: UMBRA LLC, Buffalo, NY (US)

(21) Appl. No.: 12/978,090

(22) Filed: Dec. 23, 2010

(51) Int. Cl. A01K 63/00

(52) U.S. Cl. 119/269

(57) ABSTRACT

An aquarium assembly comprising a housing having an interior floor, the housing including one or more apertures, and an aquarium operatively arranged within the housing such that the aquarium is visible through the one or more apertures, where the aquarium matingly engages the interior floor when the aquarium is nested within the housing.

### FIELD OF THE INVENTION

The invention broadly relates to aquariums and, more particularly, to an aquarium assembly including an aquarium positioned inside a housing.

### BACKGROUND OF THE INVENTION

Aquariums are well known. These moderate sized marine exhibits are often used in the home, as well as in offices, for the displaying of fish and aquatic life. Aquariums are generally polygonal shaped glass or plastic boxes in which miniature aquatic flora, stones and the like are arranged in an attractive manner inside the enclosure so as to enhance the beauty of the fish and the aquatic life. Some aquariums are hemispherically shaped—these are commonly known as “fish bowls”.

Over the years, improvements have been made to enhance the visual display of aquariums by including décor and additional structural features to the outside of a fish tank. For example, U.S. Pat. No. 4,269,142 (Hall) discloses an aquarium designed to simulate a television set. The aquarium assembly includes a one-piece frame member with a floor section and four vertical wall sections including a front wall section to simulate a television picture tube. Each wall section has openings adapted to receive a complementarily shaped, transparent sheet of material for covering the openings and enabling a passerby to view the aquatic landscape inside the aquarium as if she were watching a television program.

U.S. Patent Application No. 2009/0293814 (Rutherford, Jr. et al.) discloses a device comprising an outer cover that is configured to resemble the appearance of a house, which fits over the top of a rectangular shaped aquarium. The fish tank cover includes sidewalls having a plurality of apertures for allowing interior inspection of the aquarium without removing the device, and a top surface having a small opening to allow routine maintenance of the aquarium's parts and feeding of the fish, without removing the cover from the aquarium.

However, the disadvantages of the previously mentioned inventions are that neither the Hall nor the Rutherford, Jr. et al. inventions include carrying handles for lifting and/or carrying the tank, thus, preventing easy maneuverability of the fish tanks. In addition, neither invention is configured to be stacked one atop the other to save space when using multiple tanks.

Thus, there is a long felt need for an aquarium removably disposed within a housing, where the housing includes one or more apertures through which the aquarium (and fish swimming in the aquarium) may be viewed. In addition, there is a long-felt need for an aquarium assembly adapted to be stacked atop another identical or similar aquarium assembly, where each assembly includes carrying handles to permit easy maneuverability of the stacked assemblies.

### BRIEF SUMMARY OF THE INVENTION

The present invention broadly comprises an aquarium assembly, comprising a housing having one or more apertures therein, and, an aquarium operatively arranged within the housing such that the aquarium is visible through the one or more apertures. In one embodiment, the aquarium assembly is stackable atop other aquarium assemblies, which assemblies may be identical to one another. The housing may be constructed in a variety of shapes and sizes, including, but not limited to, square, rectangular, cylindrical, elliptical, triangular, hexagonal, octagonal, etc. Similarly, the aquarium may be constructed in a variety of shapes and sizes, including, but not limited to, square, rectangular, cylindrical, elliptical, triangular, hexagonal, octagonal, etc. In a preferred embodiment, the aquarium and housing in any given assembly are identical in shape, although the cross-sectional area of the aquarium is slightly smaller than the corresponding cross-sectional area of the housing, such that the aquarium slidingly engages and nests inside the housing. Moreover, the apertures in the housing can be of any number, size, and shape. The apertures are intended to simulate windows and/or doors in a dwelling, such as a house, hotel, condominium or the like. In a preferred embodiment, the housing is opaque and the aquarium is transparent (made of glass or acrylic material) although other configurations are possible.

It is a general object of the present invention to provide a novel, ornamental and entertaining new way to exhibit fish in an aquarium, specifically by placing the aquarium inside a housing such that the assembly resembles a dwelling such as a house, hotel or condominium.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a perspective view of the aquarium assembly of the present invention, showing an aquarium filled with water and fish, where the aquarium is disposed within a housing;

FIG. 2 is a perspective view of the aquarium assembly of the present invention;

FIG. 3 is an exploded view of the aquarium assembly shown in FIG. 2;

FIG. 4 is a bottom perspective view of the aquarium assembly shown rotated 180° about an axis a-a′;

FIG. 5 is a front view of the aquarium assembly shown in FIG. 2;

FIG. 6 is a front view of the aquarium assembly shown in FIG. 5 with a second aquarium assembly stacked atop thereof;

FIG. 7 is a top view of the aquarium assembly shown in FIG. 2;

FIG. 8 is a bottom view of the aquarium assembly shown in FIG. 2;

FIG. 9 is a cross-sectional view taken generally along line 9-9 in FIG. 7;

FIG. 10a illustrates an alternative cylindrical embodiment of the aquarium assembly of the present invention;

FIG. 10b illustrates the alternative cylindrical embodiment of the aquarium assembly shown in FIG. 10a with a second similarly shaped aquarium assembly stacked atop thereof;

FIG. 11a illustrates an alternative hexagonal shaped embodiment of the aquarium assembly of the present invention; and,

FIG. 11b illustrates an alternative hexagonal shaped embodiment of the aquarium assembly shown in FIG. 11a with a second similarly shaped aquarium assembly stacked atop thereof.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and, as such, may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs.

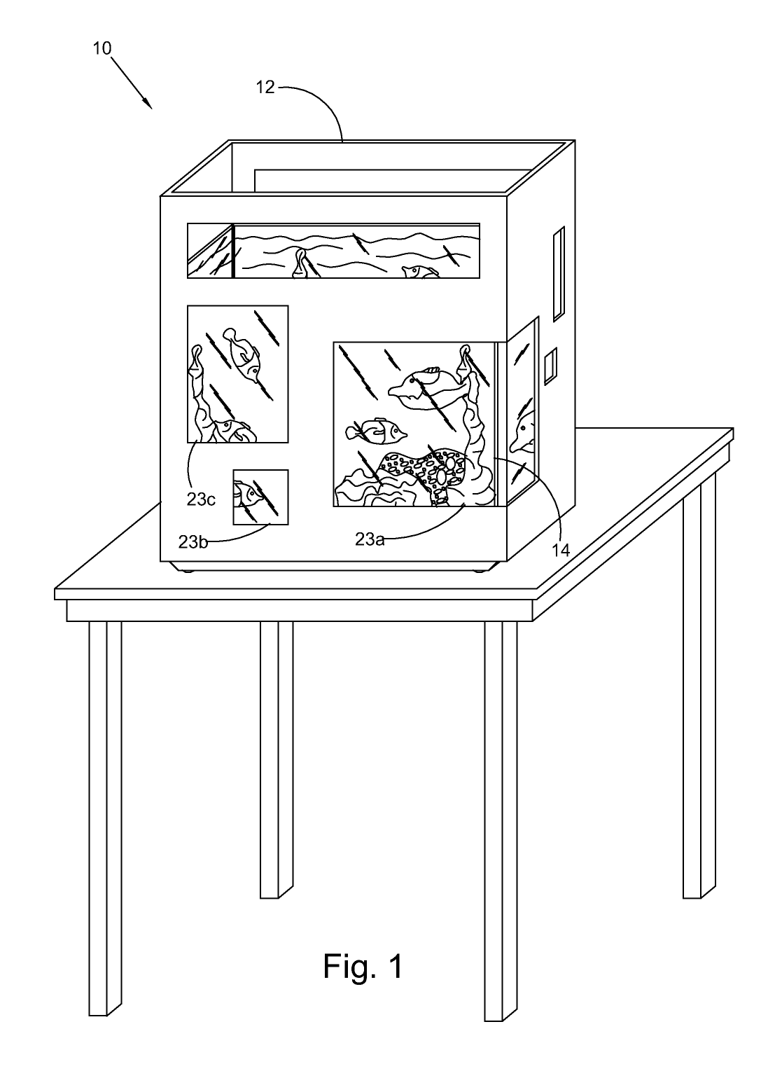

Adverting now to FIG. 1, which is a view of aquarium assembly 10 of the present invention, showing aquarium 14 filled with water and fish, where the aquarium is disposed within housing 12. Housing 12 includes at least one or more apertures 23a, 23b, and 23c such that the contents inside the aquarium (i.e., fish, aquatic flora, stones, or the like) are visible through the one or more apertures.

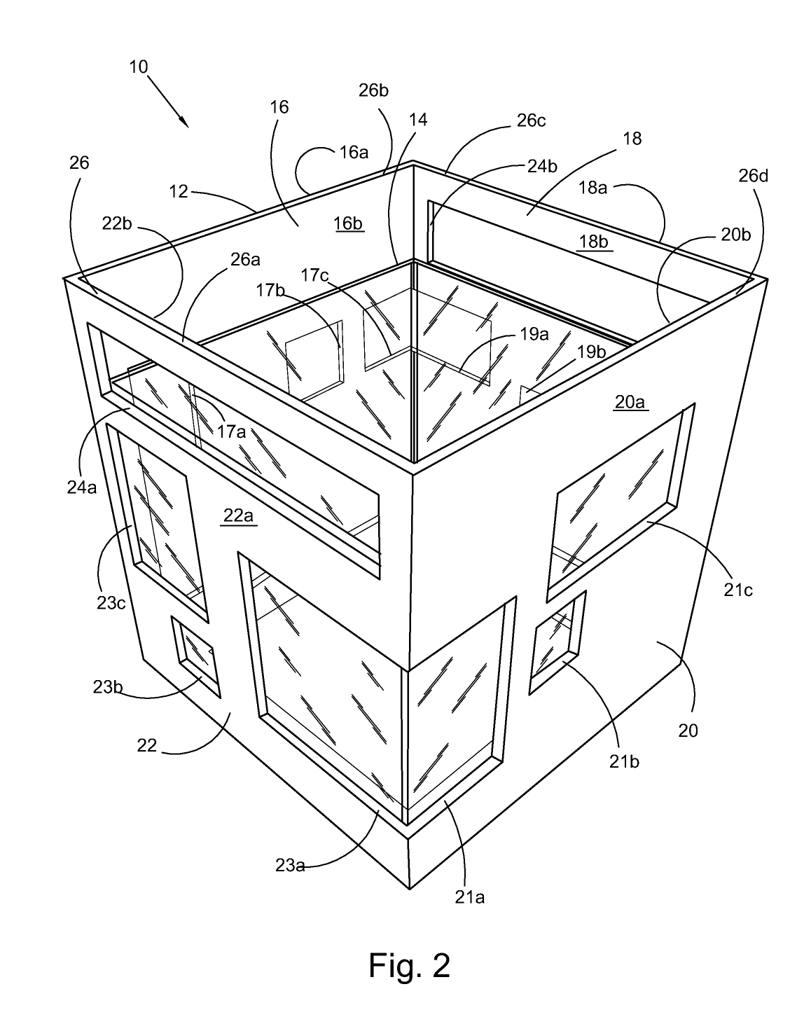

FIG. 2 is a perspective view of aquarium assembly 10 including housing 12 and aquarium 14. In a preferred embodiment, housing 12 is square or cube shaped and includes multiple sidewalls: front wall 22, first sidewall 16, second sidewall 20, and rear wall 18 that form top edge 26. Specifically, front wall 22 is seen to comprise outer surface 22a, inner surface 22b, and top edge 26a; first sidewall 16 is seen to comprise outer surface 16a, inner surface 16b, and top edge 26b; second sidewall 20 is seen to comprise outer surface 20a, inner surface 20b, and top edge 26d; and rear wall 18 is seen to comprise outer surface 18a, inner surface 18b, and top edge 26c. Preferably, the outer and inner surface of each wall is flat or planar. However, the outer surface of each wall may be non-planar. In the present embodiment, front wall 22 and rear wall 18 are spaced apart and parallel to one another. Similarly, sidewalls 16 and 20 are spaced apart and parallel to one another. All four walls are joined together to form a square shell or housing. The housing may be constructed in a variety of shapes and sizes, including, but not limited to, rectangular, cylindrical, elliptical, triangular, hexagonal, octagonal, etc. It should be understood that the shape of the housing may include a single continuous sidewall such as, for example, cylindrical shaped. Preferably, the housing is shaped to include a sidewall having identical multiple sides and angled corners that are equal, e.g., a cube. However, the housing may be shaped to comprise a sidewall having unequal multiple sides and angled corners that are unequal, e.g., a parallelepiped. Each wall is substantially identical apart from a plurality of apertures that are randomly arranged throughout the surface of the walls. Specifically, front wall 22 is seen to comprise apertures 23a, 23b, 23c, and 24a; first sidewall 16 is seen to comprise apertures 17a, 17b, and 17c; second sidewall 20 is seen to comprise apertures 21a, 21b, and 21c; and rear wall 18 is seen to comprise apertures 19a, 19b, and 24b. As shown in FIG. 2, each wall is joined together to form four corners of housing 12. In the present embodiment, the corners are sharp or pointed; however, the corners can be curved or rounded. As illustrated in the present embodiment apertures 21a and 23a are perpendicularly arranged and integrally joined together at a first corner of housing 12. Similarly, apertures 17c and 19a are perpendicularly arranged and integrally joined together at a corner opposite the first corner of housing 12.

In a preferred embodiment, apertures 24a and 24b are oppositely arranged and are positioned proximate top edge 26 or top opening 27. This arrangement is particularly advantageous because the oppositely arranged openings enables a user to grasp housing 12 within apertures 24a and 24b and conveniently lift and maneuver the aquarium assembly to a desired location. It should be understood that the plurality of apertures can be any shape such as, for example, circular, triangular, elliptical, hexagonal, oval, or the like. Preferably, each opening is rectangular shaped. In the present embodiment, housing 12 may be made of any suitable substantially rigid material such as, for example, molded plastic, cast metal, formed wood, or the like. In a preferred embodiment, housing 12 is made of medium density fiberboard.

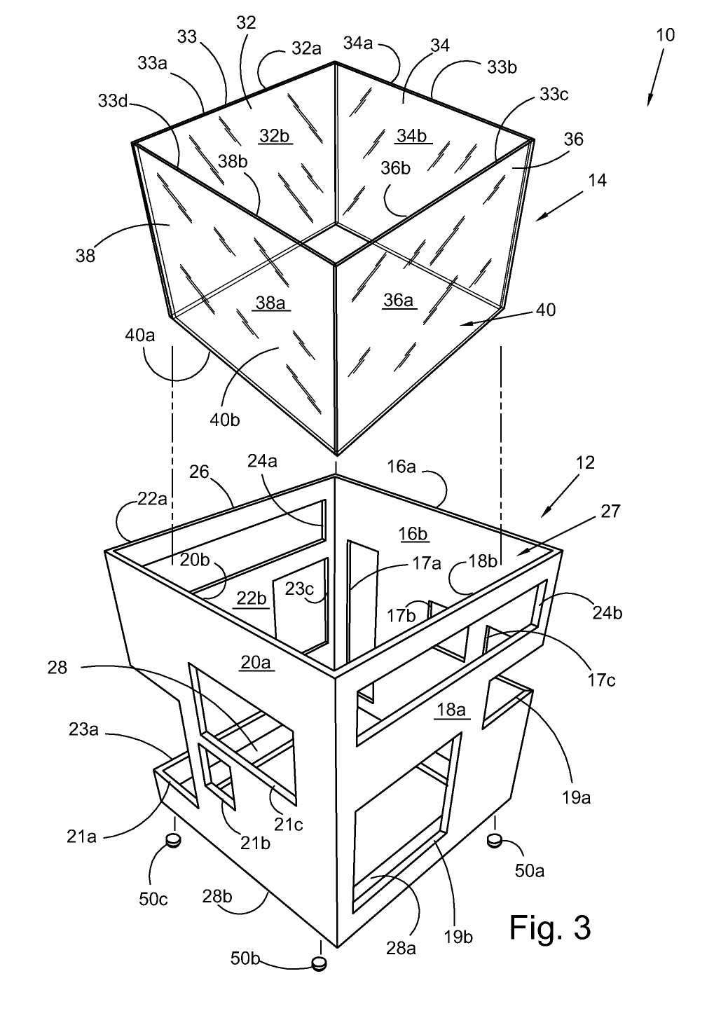

FIG. 3 is an exploded view of the aquarium assembly shown in FIG. 2 illustrating aquarium 14 and housing 12 being complementarily shaped. In a preferred embodiment, aquarium 14 comprises first wall 32, second wall 34, third wall 36, fourth wall 38, floor section 40, and top edge 33. Specifically, first wall 32 is seen to comprise outer surface 32a, inner surface 32b, and top edge 33a; second wall 34 is seen to comprise outer surface 34a, inner surface 34b, and top edge 33b; third wall 36 is seen to comprise outer surface 36a, inner surface 36b, and top edge 33c; fourth wall 38 is seen to comprise outer surface 38a, inner surface 38b, and top edge 33d; and floor section 40 is seen to comprise top surface 40b, bottom surface 40a. Similar to the housing, the aquarium may be constructed in a variety of shapes and sizes, including, but not limited to, square, rectangular, cylindrical, elliptical, triangular, hexagonal, octagonal, etc. In a preferred embodiment, the aquarium and housing in any given assembly are identical in shape, although the cross-sectional area of the aquarium is slightly smaller than the corresponding cross-sectional area of the housing, such that the aquarium slidingly engages and nests inside the housing. It should be understood that aquarium 14 may be made of translucent or transparent material. In a preferred embodiment, housing 12 is opaque and the aquarium is transparent (made of glass or acrylic material) although other configurations are possible. All four walls and bottom section are sealablely engaged to form a rectangular shaped basin; however, each wall and floor section can be integrally formed together into a leak proof aquarium. Preferably, all four walls are similarly dimensioned to form a substantially cube shaped basin when joined together.

In the present embodiment, housing 12 further comprises top opening 27 and interior floor 28 having top surface 28a and bottom surface 28b. The top opening of housing 12 is similarly shaped to aquarium 14, but slightly larger in area so that aquarium 14 can pass therethrough. Preferably, aquarium 14 is adapted to slidingly engage the top opening of housing 12 and is removably secured within housing 12. Specifically, bottom surface 40a of aquarium 14 matingly engages top surface 28a of housing 12 when the aquarium is nested therein.

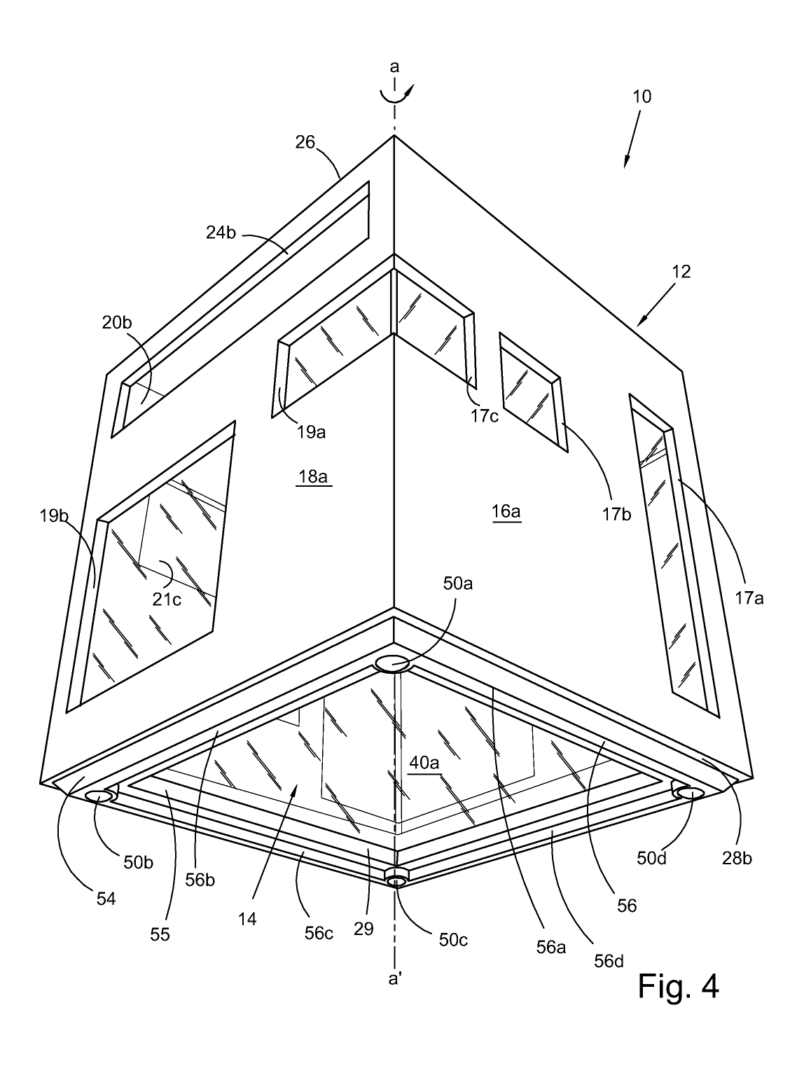

FIG. 4 is a bottom perspective view of the aquarium assembly shown in FIG. 2 illustrating the housing rotated 180° about axis a-a′ to show bottom surface 28b of housing 12. The bottom surface 28b includes bottom aperture 29 and support ridge 56 disposed therein. Support ridge 56 extends downward and away from bottom surface 28b and is operatively arranged to surround bottom aperture 29. Support ridge 56 includes first section 56a, second section 56b, third section 56c, and fourth section 56d. Specifically, first section 56a and third section 56c are spaced apart and parallel to one another. Similarly, second section 56b and fourth section 56d are spaced apart and parallel to one another. Support ridge 56 further comprises outer wall 54 and inner wall 55. The outer wall 54 includes a taper, which slopes inward toward opening 29. As shown in the present embodiment there is provided a plurality of protrusions 50a, 50b, 50c, and 50d being secured to each corner of support ridge 56. Preferably, protrusions are curved or arcuate shaped and may be made out of any suitable anti-slip material such as, for example, rubber. The rubber protrusions provide added stability to the housing, prevent slipping of the housing on smooth surfaces such as glass, and prevent the housing from scratching surfaces on which the housing is placed.

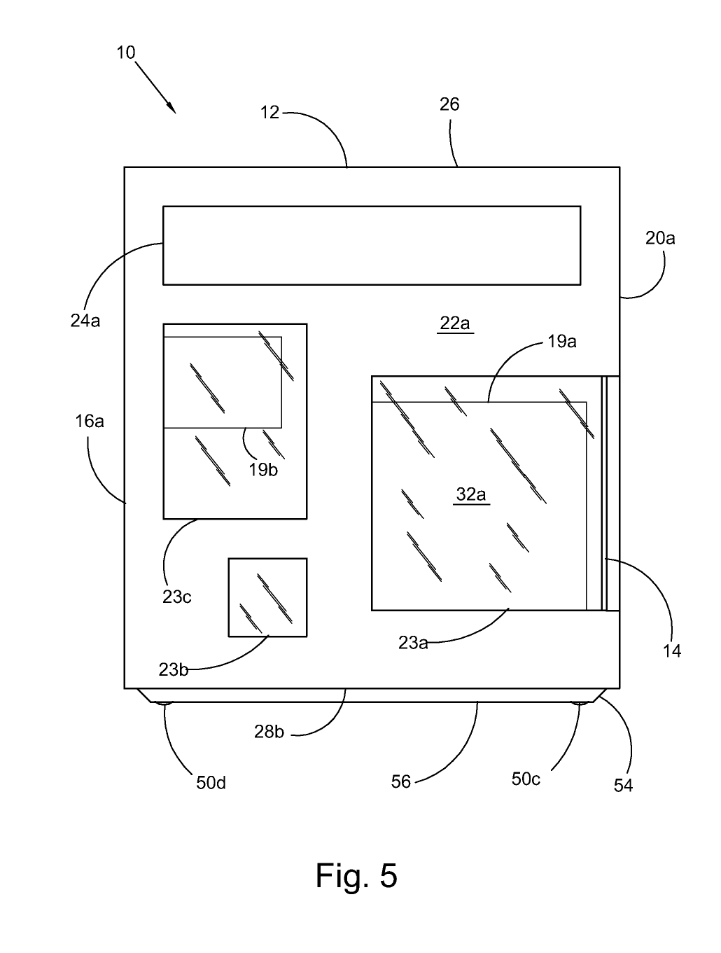

FIG. 5 shows a front plan view of aquarium assembly 10 including housing 12 and aquarium 14. The aquarium is dimensioned at a height where the walls of the aquarium overlap all but at least two apertures 24a and 24b (not shown). The oppositely arranged apertures 24a and 24b are positioned proximate top edge 26 or top opening 27 and are adapted to be used as carrying handles to permit easy maneuverability of the aquarium assembly. In addition, when the assemblies are stacked atop one another, the openings provide a means for air to circulate to prevent suffocation of the fish located in the lower aquarium assembly.

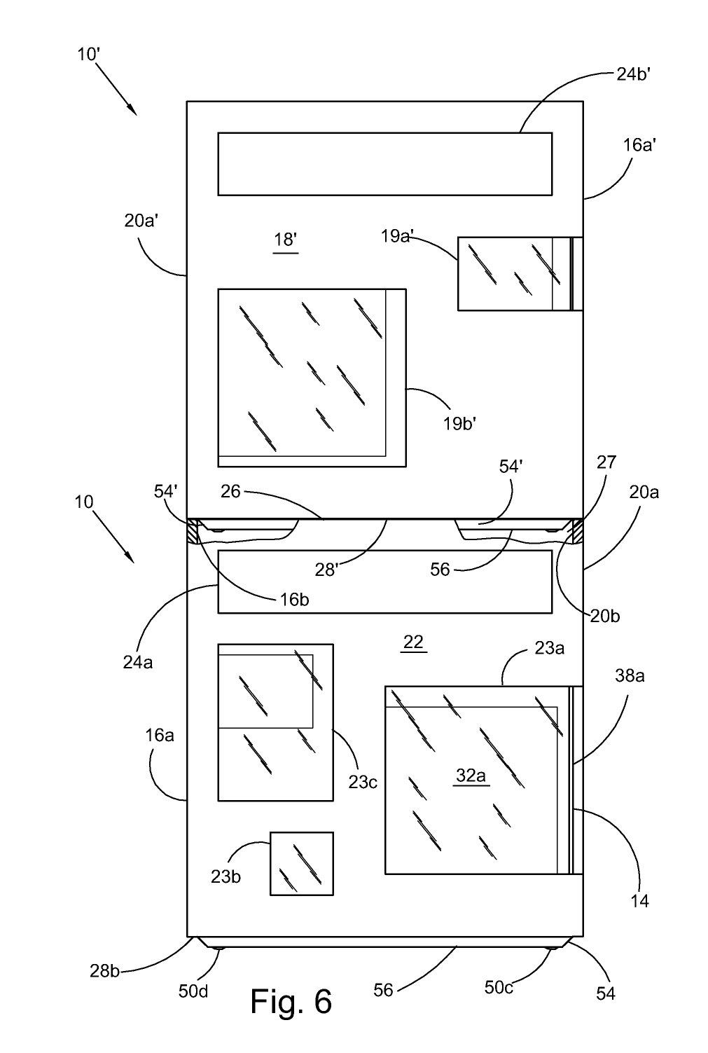

FIG. 6 is a front view of the aquarium assembly shown in FIG. 5 and an additional aquarium assembly stacked atop the first assembly. Specifically, assembly 10 is arranged to show front wall 22 having apertures 23a, 23b, 23c, and 24a and assembly 10′ being stacked atop assembly 10, is arranged to show rear wall 18′ having apertures 19a′, 19b′, and 24b′. Preferably, top opening 27 of assembly 10 is adapted to receive support ridge 56′ of similar assembly 10′ stacked on top. The support ridge is preferably positioned on bottom surface 28′ of assembly 10′ so that adequate surface area is available for top edge 26 of assembly 10 to matingly engage with bottom surface 28′ of assembly 10′. More preferably, support ridge 56′ includes outer wall 54′ having a tapered surface to ensure that even with different tolerances in manufacturing, a portion of bottom surface 28′ or tapered outer wall 54′ will engage with top edge 26 of assembly 10 and effectively remove any gaps or play, between outer wall 54 and inner walls 16b and 20b. The taper is preferably at an angle of about 43 to 46 degrees. The support ridge's tapered configuration provides alignment between the stacked assemblies, thus, allowing for the sidewalls of each assembly to become substantially co-planar with each other. For example, outer surface 20a′ of assembly 10′ is substantially co-planar with outer surface 16a of assembly 10. In the same way, outer surface 16a′ of assembly 10′ is substantially co-planar with outer surface 20 of assembly 10. This configuration is particularly advantageous because it enables multiple aquariums to be stacked atop one another to exhibit fish in an aquarium, such that the assembly arrangement resembles a dwelling such as a house, hotel, or condominium.

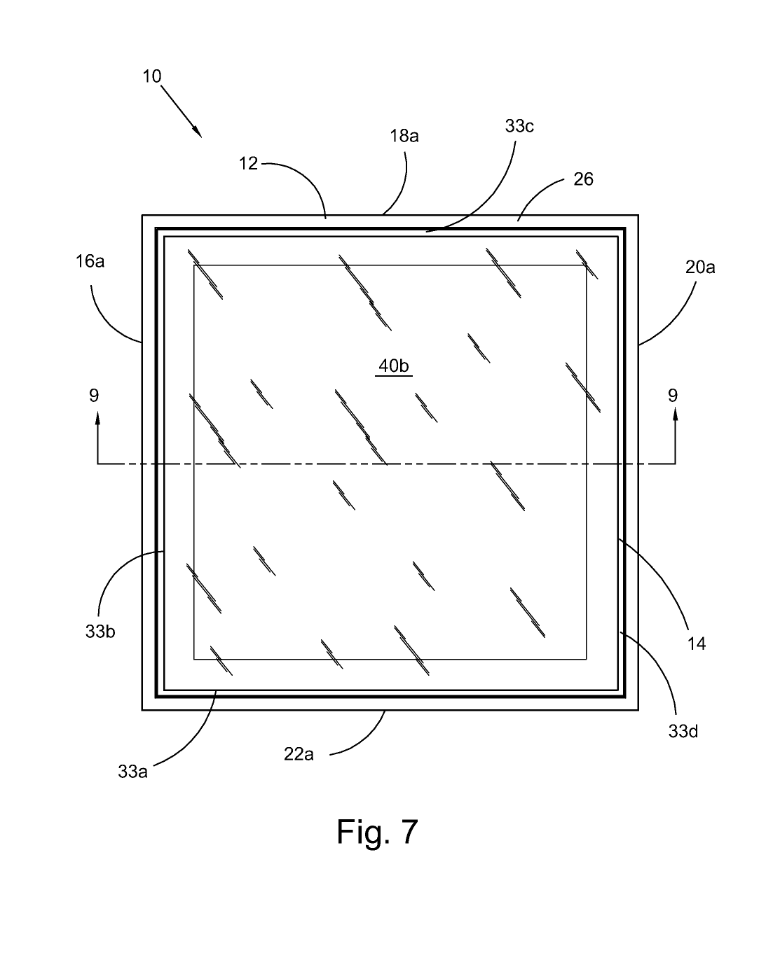

FIG. 7 is a top view of aquarium assembly 10 illustrating housing 12 and aquarium 14 having a generally square cross-section. Specifically, housing 12 and aquarium 14 are square shaped. Preferably, the second cross-sectional area of aquarium 14 is slightly smaller than the corresponding first cross-sectional area of housing 12, such that the aquarium slidingly engages and nests inside the housing.

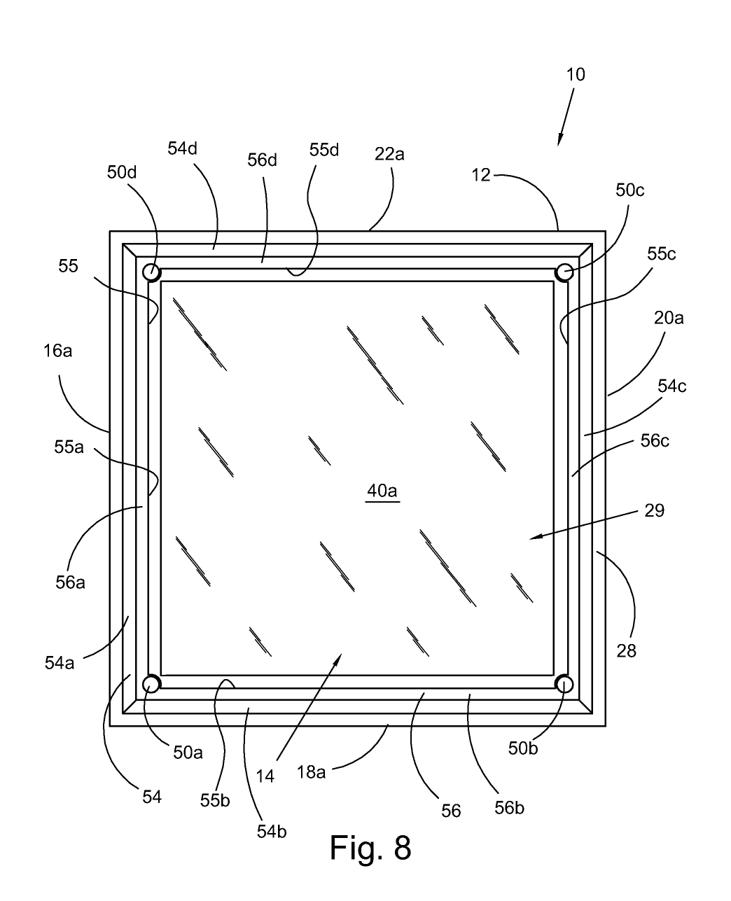

FIG. 8 is a bottom view of the aquarium assembly illustrating housing 12 including bottom surface 28 having bottom aperture 29. Bottom surface includes support ridge 56 disposed therein. Support ridge 56 includes first section 56a, second section 56b, third section 56c, and fourth section 56d. First section 56a is seen to comprise inner wall 55a and outer wall 54a; second section 56b is seen to comprise inner wall 55b and outer wall 54b; third section 56c is seen to comprise inner wall 55c and outer wall 54c; and fourth section 56d is seen to comprise inner wall 55d and outer wall 54d. All four sections of support ridge 56 are uniform in height and integrally joined together to form a generally square shaped cross-section; however, the cross-sectional shape of the support ridge is not limited to, rectangular, cylindrical, elliptical, triangular, hexagonal, octagonal, etc. In a preferred embodiment, support ridge 56 is seen to be continuous, i.e., unitary; however, the support ridge can be uniformly or variably segmented. Support ridge 56 is positioned between the outer edge of bottom surface 28 and the outer edge of bottom aperture 29, thus, surrounding bottom-opening 29. Preferably, bottom aperture 29 is seen to be square shaped although the bottom aperture can be any shape. It is particularly advantageous that bottom aperture 29 is sized accordingly to give a user access to bottom surface 40a of aquarium 14 allowing the user to push the aquarium up and away from the housing to separate the assembly for cleaning.

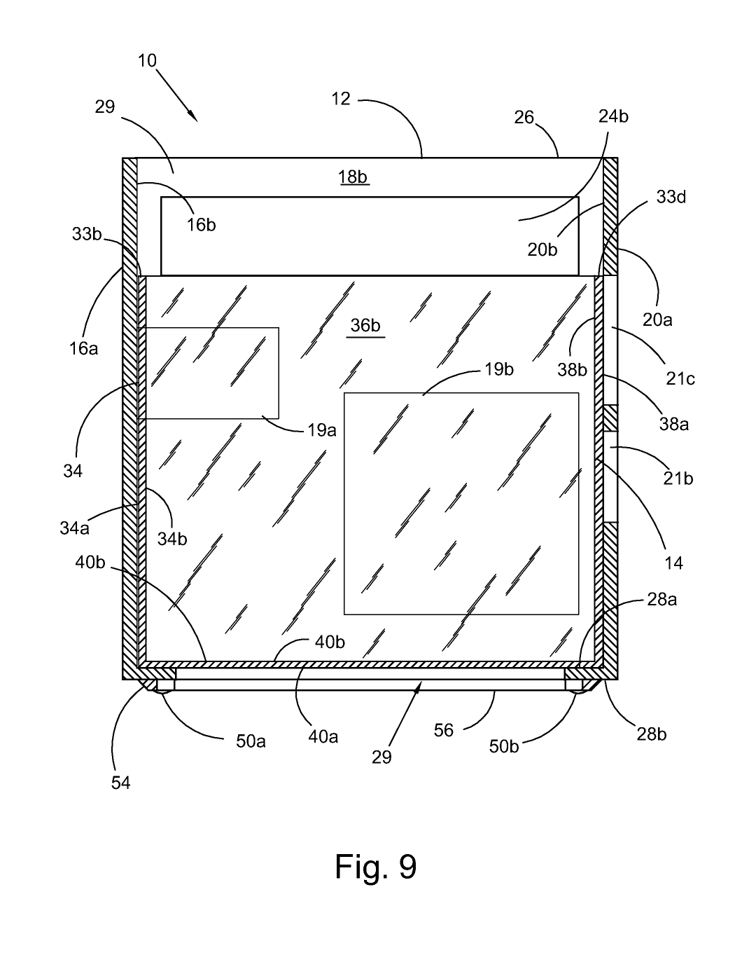

FIG. 9 is a cross-sectional view taken generally a long line 9-9 in FIG. 7. Aquarium 14 is nested within housing 12. By “within”, we mean that the sidewalls and the bottom wall of the aquarium, when nested, are in contact with an adjacent sidewall and bottom surface of the housing. For example, outside surface 34a of aquarium 14, when nested, is in contact with inner surface 16b of housing 14; outside surface 38a of aquarium 14, when nested, is in contact with inner surface 20b of housing 14; and bottom surface 40a of aquarium 14, when nested, is in contact with inner surface 28a of housing 14. As seen in FIG. 9, aquarium 14 is dimensioned at a height where the walls of the aquarium overlap all but at least two apertures 24a (not shown) and 24b.

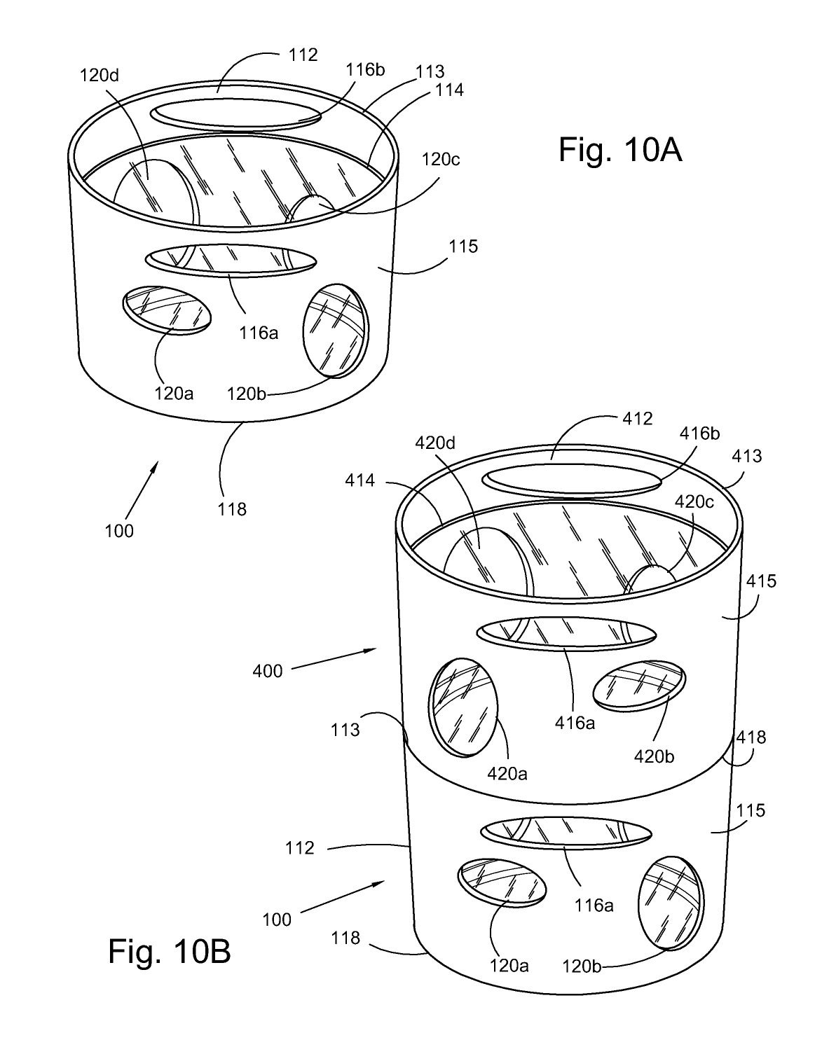

While FIGS. 1 through 9 show the aquarium assembly comprising an aquarium and a housing that is substantially rectangular or square shaped, it should be appreciated that the particular shape of the post body and post members may be modified without departing from the scope of the appended claims. In alternative embodiments, in accordance with the invention, the aquarium and housing may be any shape, such as, cylindrical, hexagonal, oval, or the like. For example, FIG. 10a illustrates a perspective view of a second embodiment of aquarium assembly 100, which is seen to comprise aquarium 114 nested within housing 112 where aquarium 114 and housing 112 are cylindrically shaped. In the present embodiment, housing 112 includes continuous sidewall 115 having top edge 113 and bottom portion 118. Sidewall 115 is seen to comprise apertures 120a, 120b, 120c, 120d, 116a, and 116b. FIG. 10b illustrates the alternative cylindrical embodiment of the aquarium assembly shown in FIG. 10a and an additional similarly shaped aquarium assembly stacked atop the first assembly. Specifically, additional assembly 400 is seen to comprise aquarium 414 nested within housing 412 where aquarium 414 and housing 412 are cylindrical in shape. Housing 412 includes continuous sidewall 415 having top edge 413 and bottom portion 418. Sidewall 415 is seen to comprise apertures 420a, 420b, 420c, 420d, 416a, and 416b. Assembly 400 is seen to be stacked atop of assembly 100 where sidewall 415 and sidewall 115 of each assembly are substantially co-planar with each other.

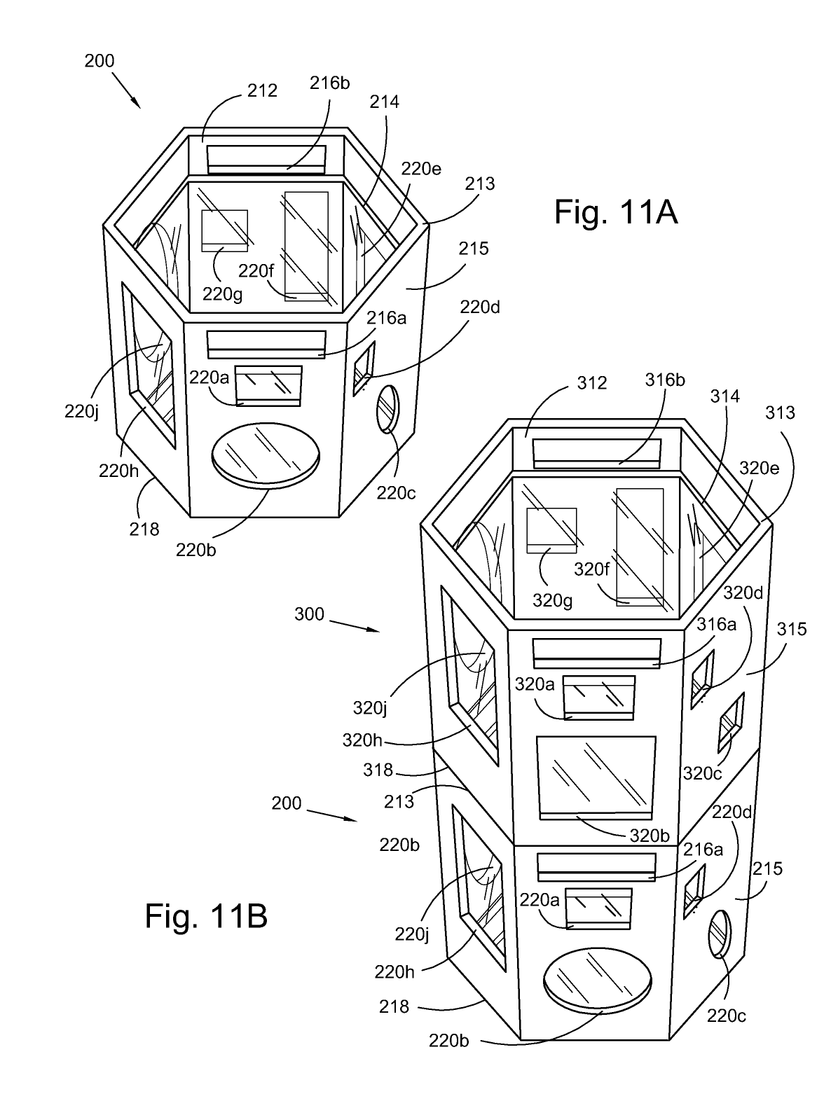

FIG. 11a illustrates a perspective view of a third embodiment of aquarium assembly 200, which is seen to comprise aquarium 214 nested within housing 212 where aquarium 214 and housing 212 are hexagonally shaped. In the present embodiment, housing 212 includes a six sided sidewall 215 having top edge 213 and bottom portion 218. Sidewall 215 is seen to comprise apertures 220a, 220b, 220c, 220d, 220e, 220f, 220g, 220h, 220j, 216a, and 216b. The apertures are seen to comprise different shapes such as, for example, 220a, 220d, 220e, 220f, 220g, 220h, 216a, and 216b are rectangular shaped while 220b, 220c, and 220j are circular shaped. FIG. 11b illustrates the alternative cylindrical embodiment of the aquarium assembly shown in FIG. 11a and an additional similarly shaped aquarium assembly stacked atop the first assembly. Specifically, additional assembly 300 is seen to comprise aquarium 314 nested within housing 312 where aquarium 314 and housing 312 are hexagonal in shape. In the present embodiment, housing 312 includes a six sided sidewall 315 having top edge 313 and bottom portion 318. Sidewall 315 is seen to comprise apertures 320a, 320b, 320c, 320d, 320e, 320f, 320g, 320h, 320j, 316a, and 316b. The apertures are seen to comprise different shapes such as, for example, 320a, 320b, 320c, 320d, 320e, 320f, 320g, 320h, 316a, and 316b are rectangular shaped while opening 320j is circular shaped. Assembly 300 is seen to be stacked atop of assembly 200 where each respective side of sidewall 315 and sidewall 215 of each assembly are substantially co-planar with each other.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What is claimed is:

1. An aquarium assembly, comprising:
a housing having an interior floor, said housing includes a plurality of apertures; and,
an aquarium operatively arranged within said housing such that said aquarium is visible through said one or more apertures, and said aquarium matingly engages with said interior floor when said aquarium is nested within said housing.

2. The aquarium assembly recited in claim 1 wherein said aquarium is removablely arranged within said housing.

3. The aquarium assembly recited in claim 1 wherein said housing and said aquarium are similar in shape.

4. The aquarium assembly recited in claim 3 wherein said housing and said aquarium are identical in shape.

5. The aquarium assembly recited in claim 2 wherein said housing has a first cross-sectional area, said aquarium has a second cross-sectional area, and said first cross-sectional area is larger than said second cross-sectional area.

6. The aquarium assembly recited in claim 3 wherein said housing and said aquarium are rectangularly shaped.

7. The aquarium assembly recited in claim 3 wherein said housing and said aquarium are hexagonally shaped.

8. The aquarium assembly recited in claim 1 wherein said housing and said aquarium each have a continuous sidewall.

9. The aquarium assembly recited in claim 8 wherein said housing and said aquarium are cylindrically shaped.

10. The aquarium assembly recited in claim 1 wherein said apertures are rectangularly shaped.

11. The aquarium assembly recited in claim 1 wherein said apertures are circularly shaped.

12. The aquarium assembly recited in claim 1 wherein said housing further comprises a top opening, a bottom surface having a bottom aperture; a support ridge positioned on the bottom surface and having an inner edge and an outer edge, wherein said top opening is adapted to receive said support ridge of a similar housing stacked on top.

13. The aquarium assembly recited in claim 12 wherein said support ridge surrounds the bottom aperture.

14. The aquarium assembly recited in claim 12 wherein said outer wall tapers inward toward said inner wall.

15. The aquarium assembly recited in claim 12 wherein said support ridge is continuous.

16. The aquarium assembly recited in claim 12 wherein at least two apertures from said plurality of apertures are oppositely arranged and positioned proximate said top opening of said housing.

17. The aquarium assembly recited in claim 16 wherein said aquarium overlaps all but said at least two oppositely arranged apertures when said aquarium is nested within said housing.

18. An aquarium assembly comprising:
a housing having multiple sidewalls, each said sidewall includes an outer surface and an said interior floor, a planar bottom surface having a bottom aperture, a top opening;
wherein said bottom surface includes a support ridge disposed therein and surrounds said bottom aperture; said multiple sidewalls include a plurality of apertures arranged within said continuous wall, wherein at least two apertures from said plurality of apertures are oppositely arranged and positioned proximate said top opening; and,
an aquarium removably secured to and operatively arranged within said housing such that said aquarium is visible through said one or more apertures, and said aquarium matingly engages with said interior floor of said housing and said aquarium overlaps all but said at least two oppositely arranged apertures when said aquarium is nested within said housing.
